(19) United States
(12) Patent Application Publication
(10) Pub. No.: US 2003/0142951 A1
(43) Pub. Date: Jul. 31, 2003

(54) Exercise recording system, exercise recording device and recording medium having the computer program for exercise recording system recorded thereon

(76) Inventors: Yasuo Tsurugai, Tokyo (JP); Yoko Yanagida, Tokyo (JP)

Correspondence Address: EDWARDS & ANGELL, LLP, P.O. BOX 9169, BOSTON, MA, 02209, US

(21) Appl. No.: 10/131,422

(22) Filed: Apr. 24, 2002

(30) Foreign Application Priority Data
Jan. 29, 2002 (JP) JP 2002-20742
Apr. 8, 2002 (JP) JP 2002-105707

(51) Int. Cl. H04N 9/00; H04N 11/00; H04N 5/91; H04N 7/00; H04N 7/173; H04N 7/16

(52) U.S. Cl. 386/46; 725/134; 386/1; 725/142

(57) ABSTRACT

A computer program of exercise recording system of recording user's body exercise performs, in the exercise recording system, an exercise contents setting step of setting exercise contents for a plurality of body exercising parts, an exercise contents displaying step of displaying exercise contents images having a plurality of display areas corresponding to the plurality of exercising parts.

### BACKGROUND OF THE INVENTION

1. Field of the Invention

The present invention relates to an exercise recording system, an exercise recording device and a recording medium having the computer program recorded thereon. In particular, the present invention is directed to an exercise recording system for recording a user's exercise, an exercise recording device for exercise recording system and recording medium having the computer program recorded thereon.

2. Description of the Related Art

Fitness club has been used for maintaining health and improving muscular strength. In order to achieve these objectives, exercise record in the club is recorded for each member of the club, for example, by the member's writing it on a sheet by oneself.

On the other hand, there is home game machine or arcade game machine of an amusement park that uses a particular controller so that a user moves its body actually.

However, it is difficult to recognize the whole of past record from the method of writing on a sheet in the fitness club. In particular, it is difficult to visually recognize the record from the exercise that is described in the sheet. It is also difficult to determine which part of the member's body should be trained thereafter.

Further, since the game by which a user actually moves its body does not have past records regarding the user's exercise, it is difficult to use the game for improving health and muscular strength.

Therefore, the objective of the present invention is to provide an exercise recording system, an exercise recording device and a recording medium having a computer program for exercise recording system in order to resolve the above problems. The objective is achieved by the combination of the features of independent claims. Further, dependent claims define specific preferred embodiments of the present invention.

### SUMMARY OF INVENTION

According to the first aspect of the present invention, there is provided a recording medium where a computer program of exercise recording system for recording a user's body exercise is readably recorded by an exercise recording system, said computer program making the exercise recording system operate: an exercise contents setting step of setting exercise contents for a plurality of exercising parts of the body; and an exercise contents displaying step of displaying exercise contents image having a plurality of display areas corresponding to the plurality of exercising parts, respectively, based on the exercise contents thus set.

In the recording medium, the computer program may further make the exercise recording system operate: an exercise contents storing step of storing the exercise contents of the plurality of exercising parts; and an exercise contents renewing step of integrating newly set exercise contents with the exercise contents stored in said exercise contents storing step, and resetting exercise contents.

In the recording medium, said exercise contents setting step further includes: an exercise pattern setting step of setting a plurality of exercise patterns having exercise contents parameters corresponding to the plurality of exercising parts, respectively; an exercise pattern selecting step of selecting a predetermined exercise pattern from the plurality of exercise patterns that are set in said exercise pattern setting step; and an exercise pattern integrating step of setting the exercise contents parameter of the predetermined exercise pattern selected in said exercise pattern selecting step as said new exercise contents integrated in said exercise contents renewing step.

In the recording medium, said computer program may further make said exercise system operate a direction image displaying step of displaying exercise direction image for directing an exercise of the exercise pattern to the user, corresponding to the predetermined exercise pattern which is selected in the exercise pattern selecting step.

In the recording medium, said exercise contents setting step may further includes a direction completion determining step of determining whether the display of the exercise direction image of the predetermined exercise pattern is completed in said direction image displaying step, and if it is determined that the display of the exercise direction image is completed, setting the exercise contents parameter of the predetermined exercise pattern as the new exercise contents integrated in said exercise contents renewing step in said exercise pattern integrating step.

In the recording medium, said computer program may further make said exercise system operate a sound outputting step of outputting sounds corresponding to the predetermined exercise pattern that is selected in said exercise pattern selecting step.

In the recording medium, said exercise contents setting step may further includes a sound completion determining step of determining whether the sound output of said predetermined exercise pattern is completed in said sound outputting step, and if it is determined that the sound output is completed, setting the exercise contents parameter of the predetermined exercise pattern as the new exercise contents that is integrated in said exercise contents renewing step.

In the recording medium, said exercise contents setting step may further includes an exercise performance information gathering step of gathering exercise performance information based on a fact that the user actually exercises the plurality of exercising the body, and setting exercise performance parameter based on the exercise performance information as the new exercise contents of the plurality of exercising parts that is integrated in said exercise contents resetting step.

In the recording medium, said exercise contents displaying step may includes a color setting step of setting colors in the plurality of display areas of the exercise contents image corresponding to the plurality of exercising parts, respectively, based on the exercise contents.

In the recording medium, wherein said exercise contents displaying step may includes: a maximum value deciding step of deciding the maximum value among the exercise contents of the plurality of exercising parts that are integrated in said exercise contents renewing step; a maximum value comparing step of comparing the maximum value with the exercise contents of the plurality of exercising parts except the maximum value; and a maximum standard displaying step of setting the display of the plurality of display areas of the exercise contents image based on the comparison in the maximum value comparing step.

In the recording medium, said maximum standard displaying step may include a color setting step of: setting a first color in the display area corresponding to the exercising part where the exercise contents is zero, setting a second color in the display area corresponding to the exercising part of the maximum value, and setting, in the display areas corresponding to the plurality of exercising parts where exercise contents is not the maximum value, a color that is closer to the second color in a display area corresponding to the exercising part where exercise contents is closer to the maximum value, based on the comparison by said maximum value comparing step, among the colors which stepwise vary between the first color and the second color.

In the recording medium, said exercise contents displaying step may include: a standard value comparing step of comparing a predetermined standard value with the exercise contents of the plurality of exercising parts that are integrated in said exercise contents renewing step; and a predetermined standard value displaying step of setting the plurality of display areas of the exercise contents image based on the comparison in said standard value comparing step.

In the recording medium, said predetermined standard displaying step may include a color setting step of: setting a first color in the display area corresponding to the exercising part where the exercise contents is zero; setting a second color in the display area corresponding to the exercising part where the exercise contents is not less than the predetermined standard value; and setting, in the display areas corresponding to the plurality of exercising parts where exercise contents is less than the standard value, a color that is closer to the second color in a display area corresponding to the exercising part where exercise contents is closer to the predetermined standard value, based on the comparison in said standard comparing step, among the colors which stepwise vary between the first color and the second color.

In the recording medium, the exercise contents displaying step may include: a maximum value deciding step of deciding the maximum value among the exercise contents of the plurality of exercising parts that are integrated in the exercise contents renewing step; a maximum standard comparing step of comparing the maximum value with a predetermined standard value; and a set standard displaying step of, if the maximum value is less than the predetermined standard value, comparing the predetermined standard value with the exercise contents of said plurality of exercising parts and setting the plurality of display areas of the exercise contents image based on the comparison and of, if said maximum value is not less than the predetermined standard value, comparing the maximum value with the exercise contents of the plurality of exercising parts except the maximum value and setting the plurality of display areas of the exercise contents display based on the comparison.

In the recording medium, said set standard comparing step may include: a color setting step of setting a first color in the display area corresponding to the exercising part where exercise contents is zero; if said maximum value is less than said predetermined standard value, setting a second color in the display area corresponding to the exercising part where exercise contents is not less than the predetermined standard value and setting, in the display areas corresponding to the plurality of exercising parts whose exercise contents is less than the predetermined value, a color that is closer to the second color in a display area corresponding to the exercising part whose exercise contents is closer to the predetermined standard value, based on the comparison in said standard value comparing step, among the colors which stepwise vary between the predetermined first color and said predetermined second color; and if said maximum value is not less than the predetermined standard value, setting a second color in the display area corresponding to the exercising part of the maximum value, and setting, in the display areas corresponding to the plurality of exercising parts where exercise contents is not the maximum value, a color that is closer to the second color in a display area corresponding to the exercising part whose exercise contents is closer to the maximum value, based on the comparison by the maximum value comparing step, among the colors which stepwise vary between the first color and the second color.

According to the second aspect of the invention, there is provided an exercise recording device for recording a user's body exercise, said device comprising: an exercise contents setting unit for setting exercise contents for a plurality of exercising parts of the body; and an exercise contents displaying signal outputting unit for outputting exercise contents displaying signal of displaying exercise contents image having a plurality of display areas corresponding to the plurality of the exercising parts, based on the exercise contents, respectively.

According to the third aspect of the invention, there is provided an exercise recording system for recording a user's body exercise, said system comprising: an exercise recording device comprising an exercise contents setting unit for setting exercise contents for a plurality of exercising parts of said body, and an exercise contents displaying signal outputting unit for outputting exercise contents displaying signal of displaying exercise contents image having a plurality of display areas corresponding to the plurality of the exercising parts, based on the exercise contents, respectively; and a displaying device for selectively displaying an exercise contents image based on the signal from the exercise contents displaying signal outputting unit of said exercise recording device and an exercise direction image for directing the exercise to the user.

In the exercise recording system, said exercise contents setting unit of said exercise recording device may include: an exercise contents storing unit for storing the exercise contents of the plurality of exercising parts; and an exercise contents renewing unit for integrating a newly set exercise contents with the exercise contents that is stored in the exercise contents storing unit, and for resetting exercise contents.

In the exercise recording system, said exercise contents setting unit of said exercise recording device may include: an exercise pattern setting unit for setting a plurality of exercise patterns having exercise contents parameters corresponding to the plurality of exercising parts, respectively; an exercise pattern selecting unit for selecting a predetermined exercise pattern from the plurality of exercise patterns that are set by the exercise pattern setting unit; and an exercise pattern integrating unit for integrating the exercise contents parameter of the predetermined exercise patterns selected by the exercise pattern selecting unit with the new exercise contents that is integrated in the exercise contents renewing unit.

In the exercise recording system, said exercise recording device may further include a direction displaying unit for outputting a signal that making the exercise direction image corresponding to the predetermined exercise pattern selected by the exercise pattern selecting unit be displayed in the displaying device.

In the exercise recording system, said exercise contents setting unit of said exercise recording device may further include a direction completion determining unit, said direction completion determining unit determining whether outputting signal of the exercise direction image of the predetermined exercise pattern is completed in said direction displaying unit and if it is determined that the signal output of the exercise direction image is completed, setting the exercise contents parameter of the predetermined exercise pattern as the new exercise contents that is integrated in said exercise contents renewing unit, in said exercise pattern integrating unit.

The exercise recording system may further comprises a sound outputting device for outputting sound corresponding to the predetermined exercise pattern selected by the exercise pattern selecting unit.

In the exercise recording system, said exercise contents setting unit of said exercise recording device may further include a sound completion determining unit, said sound completion determining unit determining whether the sound output of the predetermined exercise pattern is completed in said sound out putting device, and if it is determined that the sound output is completed, setting the exercise contents parameter of the predetermined exercise pattern as the new exercise contents that is integrated by said exercise contents renewing unit.

The exercise recording system may further comprises: a exercise detecting device for detecting the user actually exercising its body, and said exercise contents setting unit may include, an exercise performance information gathering unit for gathering exercise performance information based on the detection of the exercise detecting device, and an exercise performance information integrating unit for setting exercising performance parameter based on the exercise performance information as the new exercise contents of the plurality of exercising parts that is integrated in said exercise contents resetting unit.

In the exercise recording system, said exercise detecting device may include: a plurality of exercise detection transmitting units attached to a plurality of the user's body parts and transmitting exercise detecting signal corresponding to the body parts if the user actually exercises said body parts; and an exercise detection receiving unit for receiving the exercise detecting signal from said plurality of exercise detection transmitting units, and for outputting information of indicating that the exercise is being performed along with information of identifying the exercising part, based on the received exercise detecting signal, as exercise performance information.

In the exercise recording system, the exercise contents displaying unit of said exercise recording device may include a color setting unit for setting a color of exercise contents image of the plurality of display areas corresponding to the plurality of exercising parts, respectively, based on the exercise contents.

In the exercise recording system, said exercise contents displaying unit of said exercise recording device may include: a maximum value setting unit for setting the maximum value among the exercise contents of said plurality of exercising parts that are integrated in the exercise contents integrating unit; a maximum value comparing unit for comparing the maximum value with the exercise contents of the plurality of exercising parts except the maximum value; and a maximum standard displaying unit for setting the exercise contents image of the plurality of the display areas based on the comparison by said maximum value comparing unit.

In the exercise recording system, said maximum standard displaying unit of said exercise contents displaying unit of said exercise recording device may include: a color setting unit, setting a first color in the display area corresponding to the exercising part where exercise contents is zero, setting a second color in the display area corresponding to the exercising part of the maximum value; and setting, in the display areas corresponding to the plurality of exercising parts whose exercise contents is not the maximum value, a color that is closer to the second color in a display area corresponding to the exercising part whose exercise contents is closer to the maximum value, based on the comparison by the maximum value comparing unit, among the colors which stepwise vary between the first color and the second color.

In the exercise recording system, said exercise contents displaying unit of said exercise recording device may include: a standard value comparing unit for comparing a predetermined standard value with the exercise contents of the plurality of exercising parts that are integrated in said exercise contents integrating unit; and a predetermined standard displaying unit for setting the exercise contents image of said plurality of display areas based on the comparison by said standard value comparing unit.

In the exercise recording, said predetermined standard displaying unit of said exercise contents displaying unit of said exercise recording device may include: a color setting unit, setting a first color in the display area corresponding to the exercising part where exercise contents is zero, setting a second color in the display area corresponding to the exercising part whose exercise contents is not less than the predetermined standard value, and setting, in said display areas corresponding to the plurality of exercising parts whose exercise contents is less than the predetermined value, a color that is closer to the second color in a display area corresponding to the exercising part whose exercise contents is closer to the predetermined standard value, based on the comparison by said standard value comparing unit, among the colors which stepwise vary between the first color and the second color.

In the exercise recording system, said exercise contents displaying unit of said exercise recording device may include: a maximum value deciding unit for deciding the maximum value among said exercise contents of the plurality of exercising parts that are integrated in said exercise contents integrating unit; a maximum standard comparing unit for comparing the maximum value with a predetermined standard value; and a set standard displaying unit, for, if the maximum value is less than the predetermined standard value, comparing the predetermined standard value with said exercise contents of the plurality of said exercising parts and setting the image having the plurality of display areas based on the comparison, and for, if said maximum value is not less than the predetermined standard value, comparing the maximum value with the exercise contents of the plurality of exercising parts except the maximum value and setting the image having the plurality of display areas.

In the exercise recording system, said set standard displaying unit of the exercise contents displaying unit in the exercise recording device may include: a color setting unit, setting a first color in said display area corresponding to the exercising part where exercise contents is zero, if said maximum value is less than the predetermined standard value, setting a second color in the display area corresponding to the exercising part where exercise contents is not less than the predetermined standard value and setting, in the display areas corresponding to the plurality of exercising parts where exercise contents is less than the predetermined value, a color that is closer to said second color in a display area corresponding to said exercising part whose exercise contents is closer to said predetermined standard value, based on said comparison by said standard value comparing step, among said colors which stepwise vary between said predetermined first color and said predetermined second color; and if said maximum value is not less than said predetermined standard value, setting a second color in said display area corresponding to said exercising part of said maximum value, and setting, in said display areas corresponding to said plurality of exercising parts whose exercise contents is not said maximum value, a color that is closer to said second color in a display area corresponding to said exercising part whose exercise contents is closer to said maximum value, based on said comparison by said maximum value comparing step, among said colors which stepwise vary between said predetermined first color and said predetermined second color.

The summary of the invention does not necessarily describe all necessary features of the present invention. The present invention may also be a sub-combination of the features described above.

### BRIEF DESCRIPTION OF THE DRAWINGS

FIG. 1 shows the exercise recording system according to an embodiment of the present invention.

FIG. 2 shows a functional block diagram of the exercise recording device.

FIG. 3 shows a flowchart of setting exercise contents while the exercise recording system according to the embodiment conducts processes of recording user's exercise.

FIG. 4 shows an example of table of matching corresponding exercise patterns with exercise contents parameters.

FIG. 5 shows an example of exercise pattern selecting image that displaying device displays when a plurality of exercise patterns are selected.

FIG. 6 shows an example of exercise direction image that is displayed by the displaying device.

FIG. 7 shows a flowchart of displaying image, based on the exercise contents while the exercise recording system of the embodiment conducts processes of recording the user's exercise.

FIG. 8 shows an example of exercise contents displayed by the displaying device.

FIG. 9 shows a functional block diagram of the exercise recording device of the exercise recording system according to the second embodiment of the present invention.

FIG. 10 shows a functional block diagram of the exercise recording device of the exercise recording system according to the third embodiment of the present invention.

FIG. 11 shows a functional block diagram of the exercise recording device of the exercise recording system according to the fourth embodiment of the present invention.

FIG. 12 shows an example of exercise contents image that is displayed by the displaying device.

FIG. 13 shows a functional block diagram of the exercise recording device of the exercise recording system according to the fifth embodiment of the present invention.

FIG. 14 shows a flowchart of processes by which the exercise recording system of the present embodiment displays image based on the exercise contents.

FIG. 15 shows a functional block diagram of the exercise recording device of the exercise recording system according to the sixth embodiment of the present invention.

FIG. 16 shows a flow chart of processes by which the exercise recording system of the present embodiment displays image based on the exercise contents.

FIG. 17 shows a block diagram of the hardware constitution of the exercise recording device of the exercise recording system according to the seventh embodiment.

FIG. 18 shows a perspective view of another exercise detecting device.

FIG. 19 shows an exploded perspective view of still another exercise detecting device.

### DETAILED DESCRIPTION OF THE INVENTION

The present invention will now be described based on the embodiments of the present invention, which do not intend to limit the claimed invention and all of the features and combinations thereof described in the embodiments are not necessarily essential for resolving means of the invention.

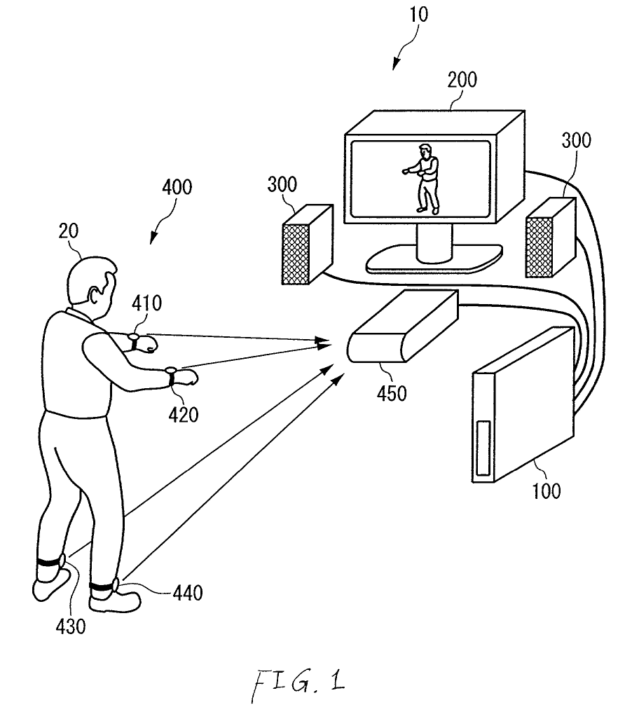

FIG. 1 shows the exercise recording system 10 according to an embodiment of the present invention. The exercise recording system 10 records a user 20's body exercise. The exercise recording system 10 has an exercise recording device 100 and an displaying device 200.

Displaying device 200 selectively displays an exercise contents image that is based on the signal from exercise contents displaying unit 120 of exercise recording device 100, and an exercise direction image that directs user 20 to exercise. In the present embodiment, displaying device 200 is separate to exercise recording device 100. However, displaying device 200 may be integral with exercise recording device 100.

Exercise recording system 10 further comprises a sound outputting device 300 for outputting sound. In the present embodiment, the sound outputting device 300 is separate to the displaying device 200. However, the sound outputting device 300 may be integral with the displaying device 200.

The exercise recording system 10 further has an exercise detecting device 400 for detecting that the user 20 actually exercises its body. The exercise detecting device 400 has a plurality of exercise detection transmitting units 410, 420, 430, 440 and an exercise detection receiving unit 450.

Exercise detection transmitting units 410, 420, 430, 440 are attached to a plurality of user 20's body parts, and transmit exercise detecting signal corresponding to the body parts when the user 20 actually exercises its body parts. In the present embodiment, the exercise detection transmitting units 410, 420, 430, 440 including a left arm exercise detection transmitting unit 410 that is attached to the user's left arm, a right arm exercise detection transmitting unit 420 that is attached to the user's right arm, a left leg exercise detection transmitting unit 430 that is attached to left leg, and a right leg exercise detection transmitting unit 440 that is attached to right leg. For example, each of these four exercise detection transmitting units has vibration sensor for detecting vibration, electronic wave transmitting unit for transmitting electronic wave as an example of exercise detecting signal based on the detection. The electronic wave transmitting units of these four exercise detection transmitting units transmit electronic waves having different frequencies with one another. From the frequency of the transmitted electronic waves, it can be identified which exercise detection transmitting unit transmits the electronic wave.

The exercise detection receiving unit 450 receives exercise detecting signal from the exercise detection transmitting units 410, 420, 430, 440 and outputs information indicating that exercise is being performed along with information identifying exercising parts as exercise performing information, based on the received exercise detecting signal.

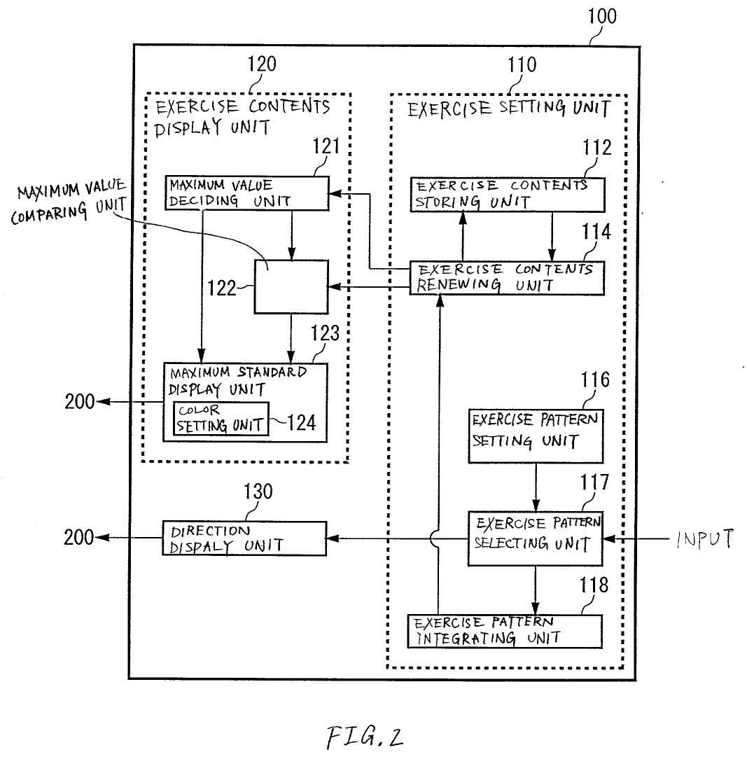

FIG. 2 shows a functional block diagram of an exercise recording device 100. The exercise recording device 100 has an exercise contents setting unit 110 and an exercise contents displaying unit 120.

The exercise contents setting unit 110 sets exercise contents for a plurality of exercising parts of the body. In the present embodiment, the exercise setting unit 110 sets the exercise contents, referring to a table. However, it is not limited thereto. In another example of the exercise contents setting unit 110 sets the exercise contents by a numerical calculation using a given function. The plurality of exercising parts of the body are divided by muscular parts that is to be trained by the exercise. For simplicity of the description, this specification divides the body into trunk, left/right upper arms that are between shoulder and elbow, left/right lower arms that are from elbow, left/right upper legs that are between ankle and knee, and left/right lower legs that are from knee, which are called as exercising parts.

The exercise contents displaying unit 120 outputs, to the displaying device 200, exercise contents image signal having a plurality of display areas which correspond to a plurality of exercising parts of the body, respectively, based on exercise contents. In the present embodiment, an example of exercise contents image having the plurality of display areas, is a model image that has a form showing human body and that divides the form into the display areas corresponding to trunk, left/right upper arms that are between shoulder and elbow, left/right lower arms that are from elbow, left/right upper legs that are between ankle and knee, and left/right lower legs that are from knee. Further, the exercise contents image of the present embodiment corresponds to a front view of a human body. However, the model image is not limited to this one. For example, the image may further use a model image corresponding to a rearview. As another example, the image maybe a model image that three-dimensionally displays a human body using so called polygonal model. In this example, the display areas corresponding to the exercising parts also may be displayed three-dimensionally. Further, in the example, the model image can be displayed upon occasion with different view points, based on the input from the user.

The exercise contents setting unit 110 includes an exercise contents storing unit 112 and an exercise contents renewing unit 114. In the present embodiment, exercise contents setting unit 110 further comprises an exercise pattern setting unit 116, an exercise pattern selecting unit 117 and an exercise pattern integrating unit 118.

The exercise contents displaying unit 120 includes a maximum value deciding unit 121, a maximum value comparing unit 122, and a maximum standard displaying unit 123. The maximum standard displaying unit 123 includes a color setting unit 124.

Further, the exercise recording device 100 further has a direction displaying unit 130. The direction displaying unit 130 outputs signal that makes the displaying device 200 to display exercise direction corresponding to an exercise pattern which is selected by the exercise pattern selecting unit.

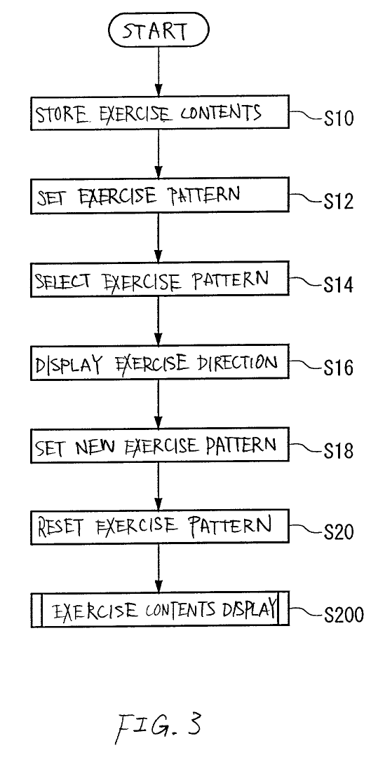

FIG. 3 shows a flowchart of setting exercise contents while exercise recording system 10 conducts processes of recording user 20's exercise according to the present embodiment.

The exercise contents storing unit 112 of the exercise recording device 100 stores exercise contents of the plurality of the exercising parts (S10). Further, the exercise contents storing unit 112 stores zero (0) as an initial value of exercise contents of each exercising part.

The exercise pattern setting unit 116 sets a plurality of exercise patterns having exercise contents parameters corresponding to a plurality of exercising parts, respectively (S12). In the present embodiment, exercise pattern setting unit 116 has tables in which the set exercise patterns and exercise contents parameters relating to the set exercise patterns. The exercise pattern means a group comprising continuous actions. As an example of the exercise pattern, in exercise employing military art, basic posture, right arm punch, left leg kick, right arm punch, basic posture and so forth can constitute a group of continuous actions.

The exercise pattern selecting unit 117 selects an exercise pattern from the plurality of exercising patterns that are set by the exercise pattern setting unit 116 (S14).

In the present embodiment, the user 20 inputs signal corresponding to the predetermined exercise pattern to the exercise pattern selecting unit 117. The exercise pattern selecting unit 117 selects an exercise pattern from the plurality of exercise patterns that are set by the exercise pattern setting unit 116, based on the input. As an example, the left arm exercise detection transmitting unit 410 and the right arm exercise detection transmitting unit 420 are used for the input from the user 20. For example, whenever exercise detecting signal is inputted from the left arm exercise detection transmitting unit 410, the exercise pattern selecting unit 117 changes the exercise pattern. If exercise detecting signal is inputted from the right arm exercise detection transmitting unit 420, the exercise pattern selecting unit 117 determines that the exercise pattern that is currently selected is selected. In this way, the user 20 can select the exercise pattern by exercise detection transmitting unit attached to its body with no necessary of separate controller, and thus, it is easy to use.

The direction displaying unit 130 outputs signal that makes exercise direction image corresponding to an exercise pattern selected by the exercise pattern selecting unit 117 to be displayed in the displaying device 200 (S16). Based on this process, the displaying device 200 displays the exercise direction image.

Next, the exercise pattern integrating unit 118 sets the exercise contents parameter of the exercise pattern selected by the exercise pattern selecting unit as new exercise contents integrated in exercise contents renewing unit (S18). For example, if “Exercise Pattern 1” is selected, exercise pattern integrating unit 118 sets exercise contents parameters corresponding to the exercise pattern in the corresponding table as new exercise contents.

The exercise contents renewing unit 114 integrates the newly set exercise contents with exercise contents for a plurality of exercising parts that are stored before, and resets the result of the integration as the current exercise contents (S20). In other words, the exercise contents parameters of the exercise pattern which is set as the new exercise contents are integrated with the exercise contents that are calculated before this exercise pattern is selected, for every exercising part. The exercise contents renewing unit 114 sets the result of the integration as the current exercise contents.

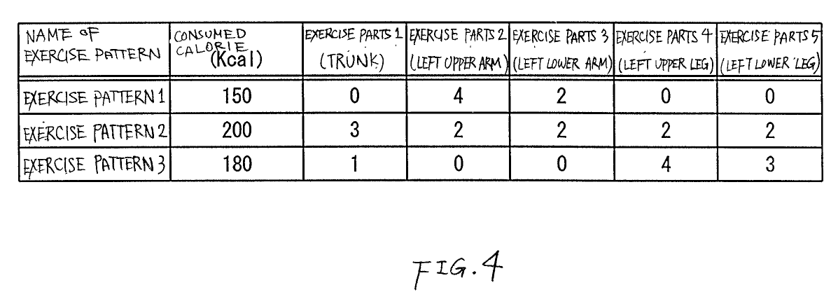

FIG. 4 shows an example of a table in which exercise patterns correspond to respective exercise contents parameters. In this table, a plurality of exercise patterns are defined by exercise pattern name. Each exercise pattern that is defined by its exercise pattern name has consumed calorie and exercise contents parameters of a plurality of exercising parts. For example, if, as described in the above, exercise pattern is a group comprising basic posture, right arm punch, left leg kick, right arm punch and basic posture, consumed calorie that is expected for these actions on the average is used as data of the table. Similarly, muscular strength and training level of exercising parts of the body that are expected for the actions on the average, are used as exercise contents parameter of each exercising part in the corresponding table.

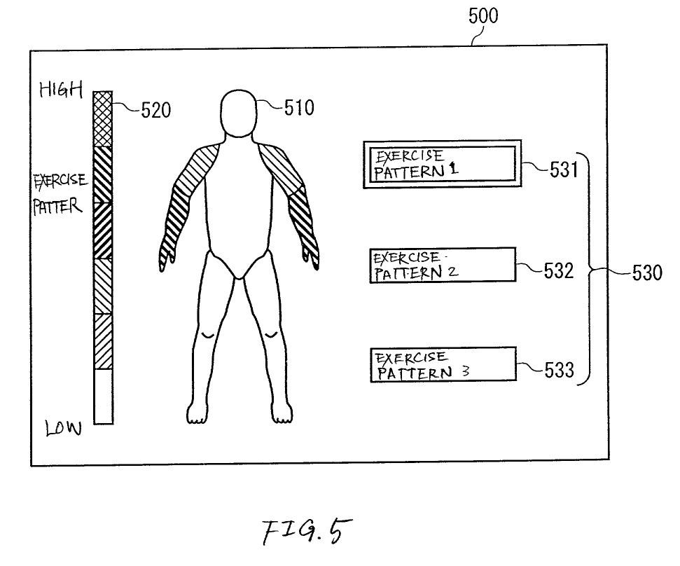

FIG. 5 shows an example of exercise pattern selecting image 500 displayed by displaying device 200 when, upon the user's input, the exercise pattern selecting unit 117 selects a particular one of a plurality of exercise patterns. The exercise pattern selecting image 500 has a field 530 where exercise pattern name identifying exercise pattern is displayed, a field 510 where exercise contents parameter corresponding to the selected exercise pattern is displayed, a field 520 where explanatory marks of exercise contents parameter that is displayed in the field 510 is displayed. In this example, three exercise pattern names of “Exercise Pattern 1,” “Exercise Pattern 2,” and “Exercise Pattern 3” are displayed in the field 530, corresponding to the table shown in FIG. 4. Further, in the exercise pattern selecting image, it is possible to let the user 20 input user ID and password for confirming the user.

For explanation, it is considered that “Exercise Pattern 1” is selected. Frame is displayed in exercise pattern name 531 of “Exercise Pattern 1” that is selected currently. For example, the frame may be displayed when a pointer on the display is positioned on the exercise pattern 531. In this way, user 20 can recognize that “Exercise Pattern 1” is selected. However, displaying the selected one is not limited to frame, and, for example, it can be done with different colors from other exercise patterns. When the currently selected exercise pattern is to be decided, acknowledgement is required by the user, with a double click and the like. Table of FIG. 4 is referenced corresponding to the selection of “Exercise Pattern 1,” and, thereby, image based on exercise contents parameter is displayed in the field 510.

In FIG. 5, it is understood that “Exercise Pattern 1”, has exercise contents parameter that is greatest in the left/right lower arms, is secondly largest in the left/right upper arms and is zero (0) in the other parts. Thus, user 20 can visually recognize exercise contents parameter corresponding to each exercise pattern before determining exercise pattern. As an example of color, display area of high exercise contents is set with warm color such as red and display area of low exercise contents is set with cold color such as blue. With these color settings, user 20 can more easily visually recognize exercise contents parameter. Further, in FIG. 5, the colors are described by different hatchings with one another.

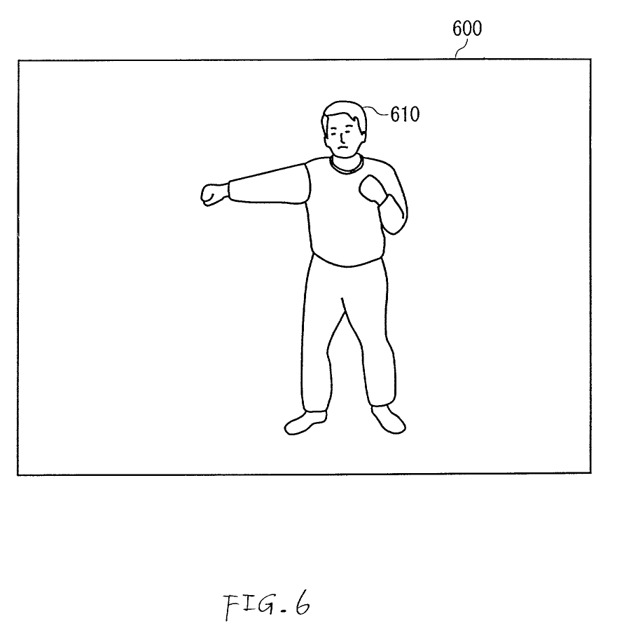

FIG. 6 shows an example of the exercise direction image 600 displayed by the displaying device 200. In the present embodiment, the exercise direction image 600 is a moving image showing that, for example, the instructor 610 exercises based on the selected exercise pattern. The user 20 exercises a plurality of its exercising parts, following the exercise direction image 600 displayed by the displaying device 200. For example, in FIG. 6, the instructor 610 directs the user 20 to do action of right arm punch in selected “Exercise Pattern 1.”

If user 20 performs exercises conforming to instructor 610's actions, a sound is generated or a special display appears on a monitor. Thus, the user can exercise with pleasure. Whether user 20's action conforms to instructor 610's direction or not, is determined based on the output of exercise detecting device 400.

As described above, in the present embodiment, the exercise detecting device 400 has a plurality of exercise detection transmitting units 410, 420, 430, 440 and an exercise detection receiving unit 450. However, it is not limited thereto.

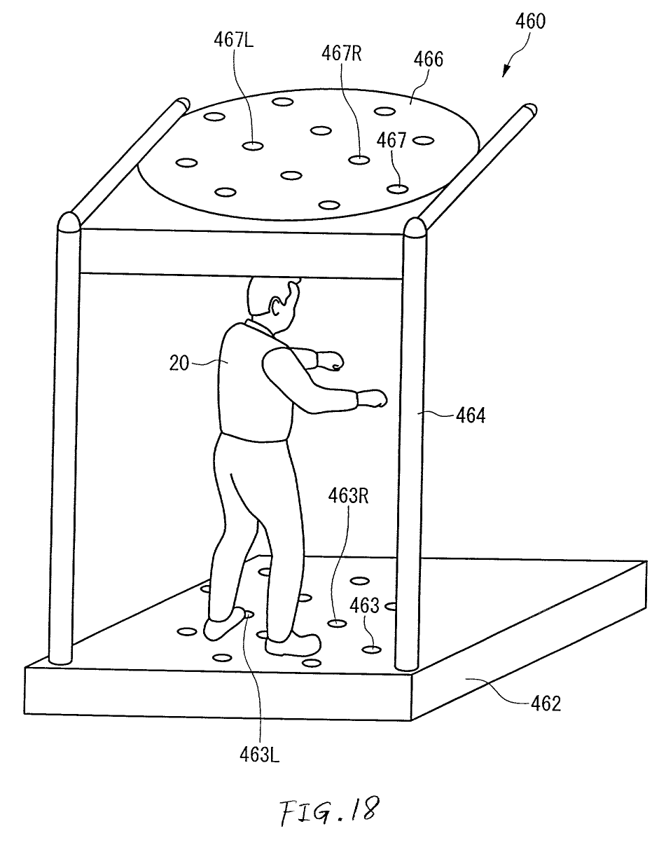

FIG. 18 shows a perspective view of another example of the exercise detecting device 460. The exercise detecting device 460 has a stage 462, a plurality of light emitting units 463, a frame 464, a roof 466 and a plurality of light receiving units 467. The stage 462 is used for the user's exercising thereon. The plurality of light emitting units 463 is arranged at the predetermined positions, and emit the light upwardly. For example, the light emitting unit 463 emits a directional infra-red light. The frame 466 extends from the stage 462 to the user's head. The roof 466 is supported by the frame 466, and positioned above the user's head. The light receiving units 467 is arranged at positions in the roof 466 corresponding to respective the light emitting unit 463. Accordingly, rays from the light emitting unit 463 are detected by the corresponding light receiving unit 464. If the user 20 exercises, his body parts such as arms or legs may be positioned above a particular light emitting unit 463. In this case, the body parts cut the ray from the light emitting unit 463, and then the ray does not reach at the corresponding light receiving unit 464. Accordingly, the light receiving unit 464 which does not receive the ray notifies the body parts of the user 20 exercise. Furthermore, markings on the stage 464 may be provided at the positions corresponding to the initial foot positions of the user 20, and light emitting units 463R, 463L may be provided at the markings.

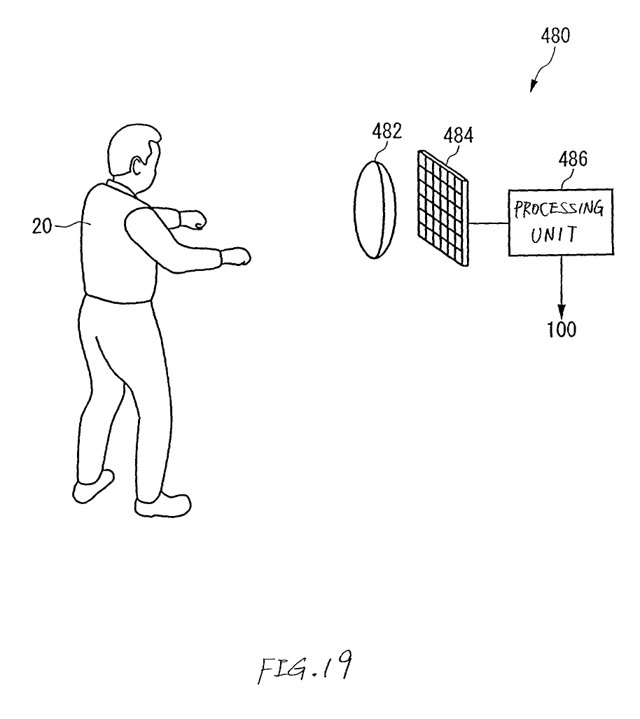

FIG. 19 shows a exploded perspective view of another exercise detecting device 480. The exercise detecting device 480 includes an artificial retina which faces at the front of the user 20. The exercise detecting device 480 has a lens 482, a CMOS sensor 484 and a processing unit 486. The lens 482 focuses the image of the user 20 on the CMOS sensor 484. The CMOS sensor 484 the image received with plural receiving elements formed on a semiconductor device, and output an electric signal. The processing unit 486 controls the CMOS sensor 484 as well as processes the electric signal from the CMOS sensor 484 to the image data. The exercise detecting device 480, by comparing the image data of predetermined time interval, detects the user's exercise. The exercise detecting device 480 outputs the detected exercise of the user 20 to the exercise recording device 100.

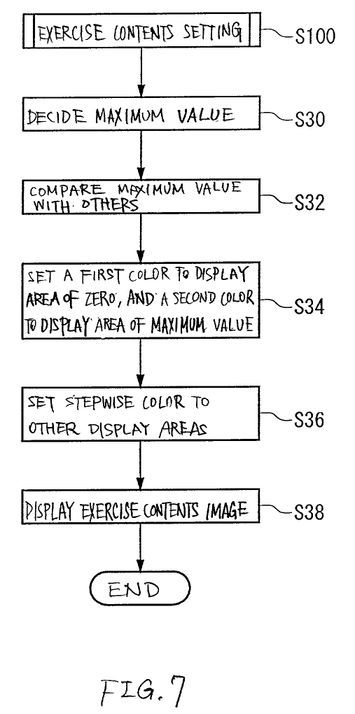

FIG. 7 shows a flowchart of process (S200) of displaying based on the exercise contents while exercise recording system 10 conducts processes of recording user 20's exercise according to the present embodiment. The process of flowchart of FIG. 7 follows the processes (S100) of the exercise contents setting in the flowchart of FIG. 6.

The maximum value deciding unit 121 decides the maximum value among the exercise contents for the plurality of exercising parts that are integrated in the exercise contents renewing unit 114 of the exercise contents setting unit 110 (S30). In the following, for example, the exercise contents for left/right lower arms is assumed as the maximum value.

The maximum value comparing unit 122 compares the maximum value with the exercise contents for the plurality of exercising parts of which exercise contents are not the maximum value (S32) The exercise contents for the left/right lower arms, left/right upper arms, trunk, left/right upper legs and left/right lower legs are compared with one another. For an example of the comparison, the exercise contents except the maximum value are expressed by percentage with respect to the maximum value. If the value of the exercise contents for left/right upper arms is 7 when the value of the exercise contents for left/right lower arms, the maximum value, is 10, the exercise contents is expressed by 70%. Further, if the value of the exercise contents for left/right upper arms is 7 when the value of the exercise contents for left/right lower arms, the maximum value, is 20, the exercise contents is expressed by 35%.

The maximum standard displaying unit 123 sets a plurality of display areas, based on the comparison of maximum value comparing unit 122. In the present embodiment, the following images are set in the plurality of display areas.

The color setting unit 124 of the maximum standard displaying unit 123 sets a first color in a display area corresponding to the exercising part wherein a value of exercise contents is zero (0), and sets a second color in a display area corresponding to the exercising part having the maximum value (S34). For example, the first color is set by cold color such as blue and the second color is set by warm color such as red. By this color setting, user 20 can more easily visually recognize the past exercise contents. In the above example, red is set for the image corresponding to the left/right lower arms. Further, if the value of exercise contents for the left/right upper legs is zero (0), blue is set for the display area corresponding to the exercising part.

In the display areas corresponding to the plurality of exercising parts except the maximum value, color setting unit 124 sets a color that is closer to a second color in a display area corresponding to the exercising part whose exercise contents is closer to the maximum value, based on the comparison by the maximum value comparing unit, among the colors which stepwise vary between the predetermined first color and the predetermined second color. For example, five colors between blue and red are prepared. According to the result of comparison by the maximum value comparing unit, color setting unit 124 sets blue in the display area of 0%, light blue in the display area between 0 & and 20%, green in the display area between 20% and 40%, yellow in the display area between 40% and 60%, orange color in the display area between 60% and 80%, and red in the display area between 80% and 100%.

Therefore, since the other display areas are relatively displayed with respect to the maximum value, exercising part whose exercise contents is relatively low regardless the absolute value can be easily recognized. In particular, if exercise contents becomes great unusually for some exercising part, such a record is outstandingly displayed.

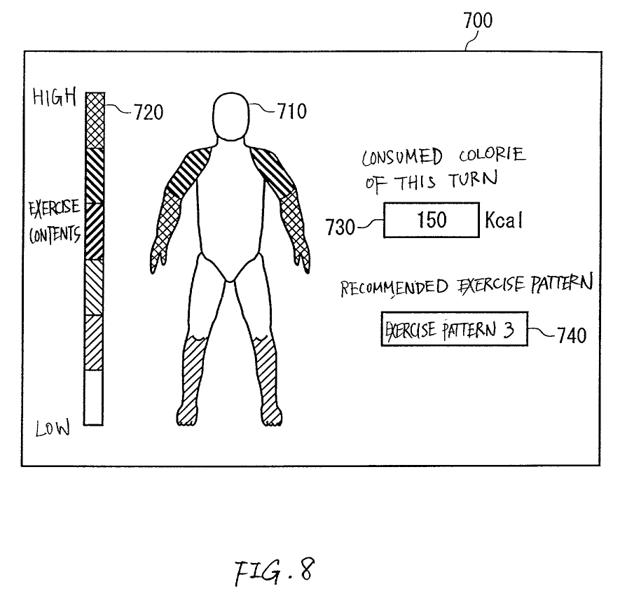

FIG. 8 shows an example of the exercise contents image 700 displayed by the displaying device 200. The displaying device 200 displays, in a field 710, the exercise contents image 710 having a plurality of display areas set as in the above (S38). Thus, the user 20 can visually recognize the exercise contents after the exercise. Further, FIG. 8 shows colors using different hatchings as in FIG. 5.

Further, in the present embodiment, consumed calorie by the exercise pattern is displayed in a field 730. Further, in the exercise contents image 700 displayed by displaying device 200, an exercise pattern that makes the exercise contents for an exercising part whose exercise contents is low to become high, is displayed in a field 740 of “Recommended Exercise Pattern.” Thus, the user 20 can easily select exercise with good balance.

According to the first embodiment, the user can visually recognize its exercise record with ease. In this way, the user can determine body parts to be trained thereafter with ease.

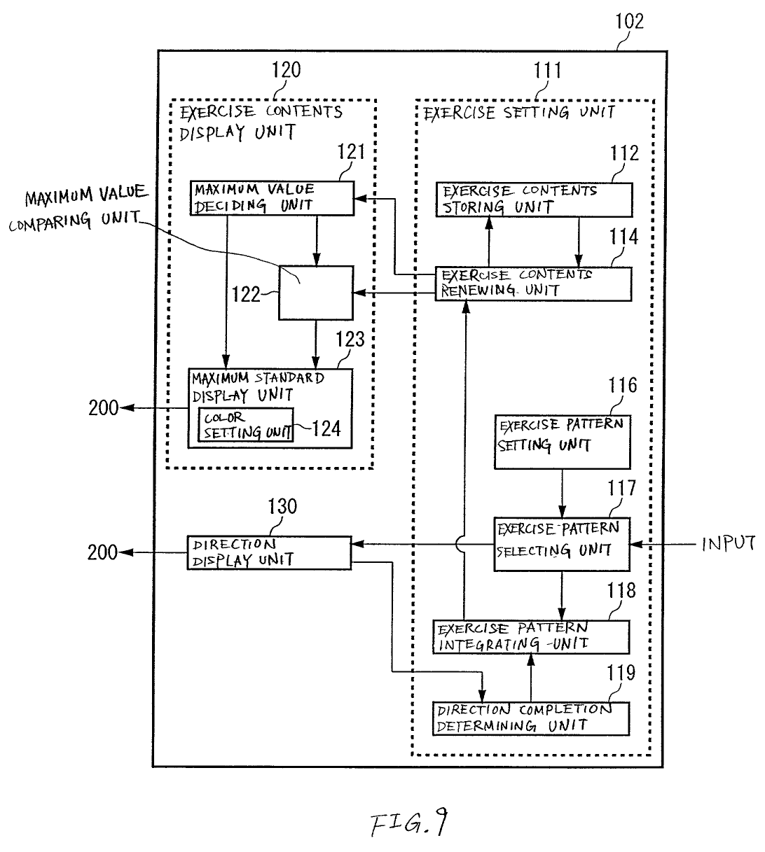

FIG. 9 shows a functional block diagram of an exercise recording device 102 in an exercise system according to a second embodiment of the present invention. Since exercise recording system of the second embodiment is different from the exercise recording system of the first embodiment only in exercise recording device 102, only different constitution will be described in the following.

The exercise recording device 102 of the second embodiment further has a direction completion determining unit 119 in exercise contents setting unit 111, compared to the exercise recording device 100 of the first embodiment. The direction completion determining unit 119 determines whether, in the direction displaying unit 130, the signal output of exercise direction image 600 of a predetermined exercise pattern directed to user 20 is completed or not. If it is determined that the signal output of exercise direction image 600 is completed, the direction completion determining unit 119 sets exercise contents pattern of a predetermined exercise pattern directed to the user 20 as a new exercise contents that is integrated in the exercise contents renewing unit 114, in the exercise pattern integrating unit 118. In this case, the exercise contents renewing unit 114 may store the resulting exercise contents which is thus integrated into the exercise contents storing unit 112.

Further, if it is determined that the signal output of exercise direction image 600 is not completed, direction completion determining unit 119 makes the new exercise contents that is integrated in exercise contents renewing unit 114 into zero (0). In this way, if user 20 does not fully exercise according the predetermined exercise pattern, exercise contents is not integrated.

In the above, the second embodiment can also provide the same effects as the first embodiment. Further, since exercise contents is integrated only when a user fully exercises according to an exercise pattern, it is possible to obtain exercise recording closer to the user's actual exercise contents. Further, it can provide motive to fully exercise according to the actions of the exercise pattern.

Further, in the second embodiment, direction completion determining unit 119 resets the exercise contents if the signal output of exercise direction image 600 of the predetermined exercise pattern is completed. However, this is not limited.

For example, it is possible that it is determined that signal output of exercise direction image 600 is completed for a group of some actions included in the exercise pattern. In this embodiment, if exercise direction image 600 is completed for a group of some actions, even though signal output of exercise direction image 600 is discontinued thereafter, amount-of-parameter based on the group of the actions may be set as new exercise contents that is integrated in exercise contents renewing unit 114.

For another example, if direction completion determining unit 119 completes a half of signal of exercise direction image 600 of the predetermined exercise pattern and the output is discontinued thereafter, it is possible that the value of a half of exercise contents parameter is set as new exercise contents that is integrated in exercise contents renewing unit 114.

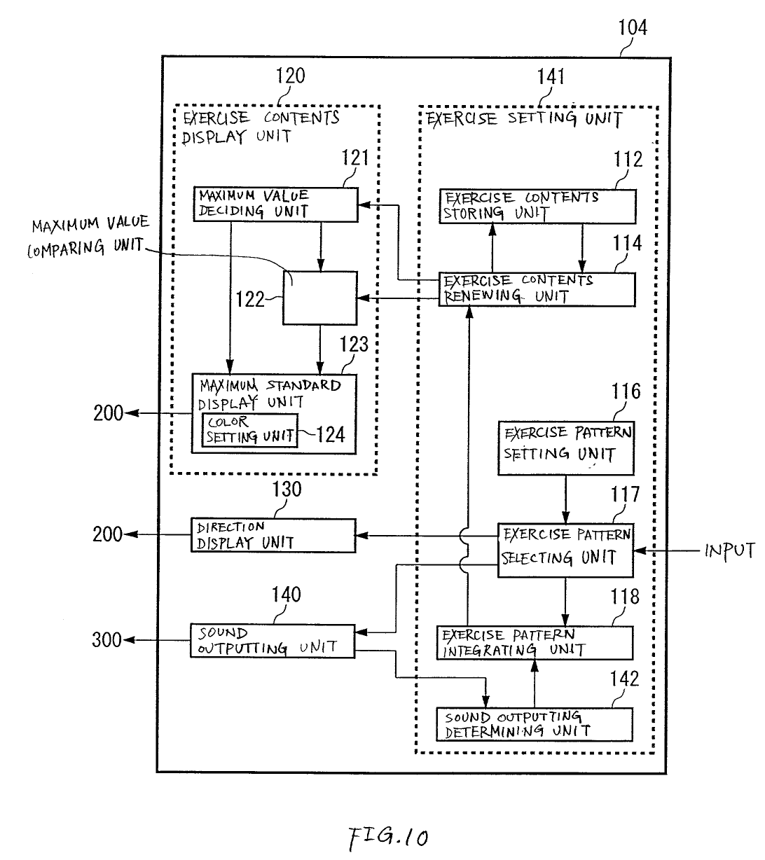

FIG. 10 is a functional block diagram of exercise recording device 104 in exercise system according to a third embodiment of the present invention. Since the exercise recording system of the third embodiment is different from the exercise recording system of the first embodiment only in exercise recording device 104, only different constitution will be described in the following.

Exercise recording device 102 of the third embodiment further has a sound outputting unit 140 for outputting sound in sound outputting device 300, and a sound completion determining unit 142 in exercise contents setting unit 141, compared to exercise recording device 100 of the first embodiment.

Sound outputting device 300 outputs sound corresponding to the predetermined exercise pattern selected by exercise pattern selecting unit 117.

Sound completion determining unit 142 determines whether sound output of the predetermined exercise pattern is completed in sound outputting device 300. If it is determined that sound output is completed, in the exercise pattern integrating unit, sound completion determining unit 142 set the exercise contents parameter of the predetermined exercise pattern as the new exercise contents that is integrated in the exercise contents renewing unit. Further, if it is determined that sound output is not completed, sound completion determining unit 142, in exercise pattern integrating unit 118, makes the new exercise contents that is integrated in exercise contents renewing unit 114 into zero (0). In this way, exercise contents is not integrated if user 20 does not fully exercise according to the predetermined exercise pattern.

The third embodiment can provide the same effects as the first and second embodiments. Further, for example, if music with danceable beat is used as sound, motive by which a user fully exercises according to the exercise pattern can be provided since a user would want to continuously listen to the music.

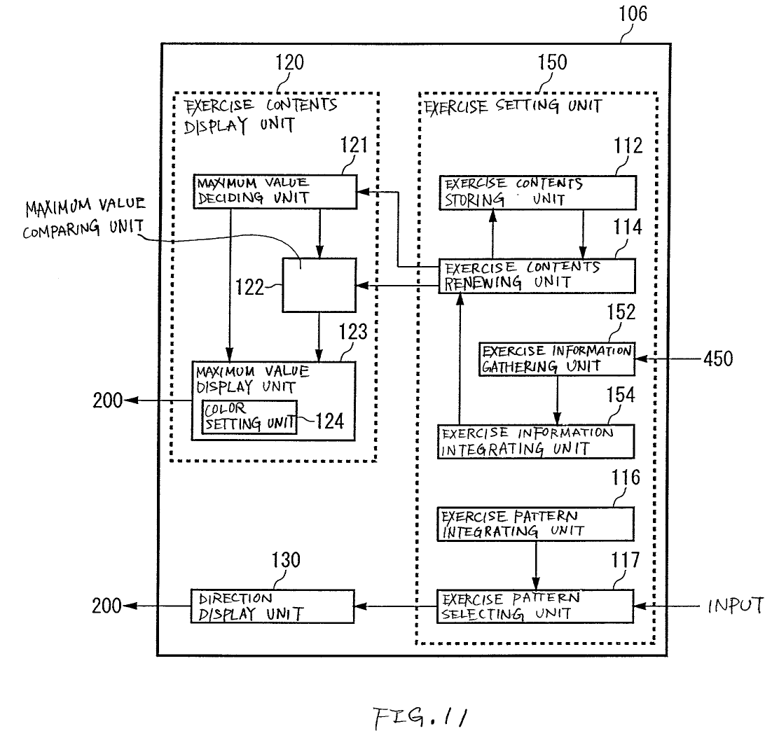

FIG. 11 shows a functional block diagram of exercise recording device 106 of exercise system according to a fourth embodiment of the present invention. The exercise recording system of the third embodiment is different from the exercise recording system of the first embodiment in exercise recording device 106.

Exercise recording device 106 of the fourth embodiment has an exercise contents setting unit 150, an exercise contents displaying unit 120 and a direction displaying unit 130. Exercise contents setting unit 150 comprises an exercise contents storing unit 112, an exercise contents renewing unit 150 as in the first embodiment. Exercise contents setting unit 150 of the present embodiment further comprises an exercise information gathering unit 152, an exercise information integrating unit 154.

Exercise performance information gathering unit 152 gathers exercise performance information based on the detection of exercise detecting device 400. As described in the above, exercise detection transmitting units 410, 420, 430, 440 of exercise detecting device 400 are attached to the plurality of user 20's body parts. If user 20 actually moves its body parts, these exercise detection transmitting units 410, 420, 430, 440 transmit exercise detecting signals corresponding to the body parts.

For example, it is assumed that user 20 punches with right arm according to the direction of exercise direction image 600. In this case, exercise detection transmitting unit 410 attached to the right arm detects the vibration and transmits exercise detecting signal with a predetermined frequency. Exercise detection receiving unit 450 receives the exercise detecting signal and identifies that the transmitting unit is the right arm exercise detection transmitting unit, based on the frequency of the exercise detecting signal. Based on this processes, exercise detection receiving unit 450 outputs exercise performance information to exercise contents gathering unit 152 of exercise recording device 100.

Exercise performance information gathering unit 154 sets exercise performance parameter based on the exercise performance information gathered by exercise information gathering unit 152 as new exercise contents of the plurality of exercising parts that is integrated in exercise contents renewing unit 114. In the present embodiment, exercise information integrating unit 154 calculates exercise performance parameters for every exercising part and integrates them whenever exercise performance from exercise performance information gathering unit 152 is inputted, while direction displaying unit 130 outputs, to displaying device 200, exercise direction image for directing a series of continuous exercises. Exercise information integrating unit 154 sets these integrated values as exercise performance parameters for each exercising part.

Further, in the present embodiment, as in the above, the number of exercising parts is nine, i.e., trunk, left/right upper arms that are between shoulder and elbow, left/right lower arms that are from elbow, left/right upper legs that are between ankle and knee, and left/right lower legs that are from the knee. On the other hand, exercise detection transmitting units for detecting exercise are four elements consisting of left arm exercise detection transmitting unit 410, right arm exercise detection transmitting unit 420, left leg exercise detection transmitting unit 430 and right leg exercise detection transmitting unit 440. The number of exercising parts does not have to conform to the number of exercise detection transmitting units. It is because exercising parts that are used for some actions are known in advance. For example, which muscle is used for the action of right punch has been already known in kinematics. Further, it is reasonable assumption that, for an exercise direction, whether the exercise is performed is determined from the fact of whether the detection of exercise detecting unit corresponding to the directed exercise exists or not. According to the above example, if, for right punch direction, at least right arm exercise detection transmitting unit 420 detects the exercise, it can be assumed that a user performs the right punch action. Therefore, if an exercise is directed, it is possible to assume that the exercise is performed and to calculate exercise contents of each of nine exercising parts from the exercise of the body parts that are known in kinematics with respect to the exercise. In this case, it is also possible to add a condition where an exercise detection unit, for example, right leg exercise detection transmitting unit 440 does not detect an exercise.

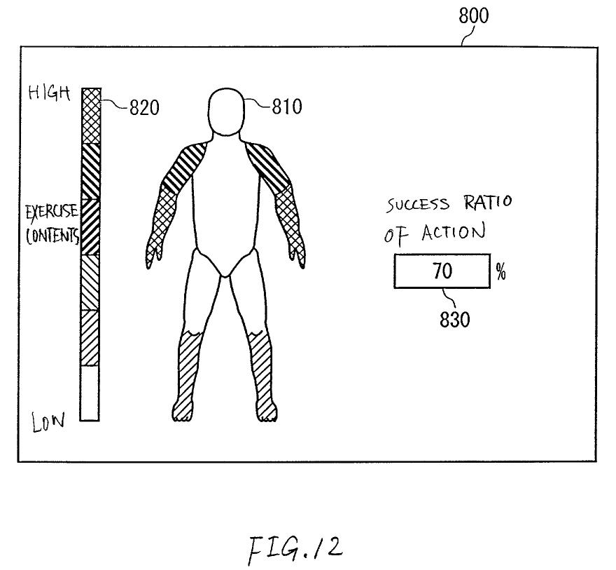

FIG. 12 shows an example of exercise contents image 800 displayed by displaying device 200. In the present embodiment, exercise contents image is displayed in field 810, based on the color that is set by comparison with the maximum value of exercise contents as the first embodiment. Further, the ratio that user 20 actually exercises conforming to a series of continuous actions that are directed at this time, is displayed in field 830. Therefore, it can be visually recognized how much ratio user 20 exercises conforming to the direction. Further, as in FIG. 5, the colors are expressed with different hatchings.

The fourth embodiment can provide the same effect as the first embodiment. Further, a user can recognize actual exercise recording more accurately since displayed exercise contents image is based on the exercise that the user actually performs.

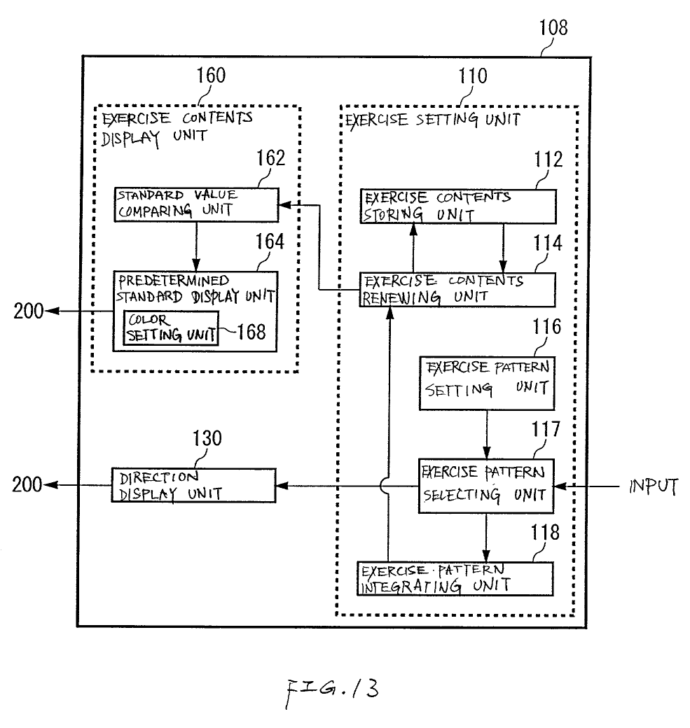

FIG. 13 shows a functional block diagram of exercise recording device 108 of the exercise system according to a fifth embodiment of the present invention. The exercise recording system of the fifth embodiment is different from the exercise recording system of the first embodiment in exercise recording device 108.

Exercise recording device 108 of the present embodiment has an exercise contents setting unit 110, a direction displaying unit 130, and an exercise contents displaying unit 160. Exercise contents setting unit 110 of exercise recording device 108 and direction displaying unit 130 are same as the first embodiment and thus, the explanation to them is omitted.

Exercise contents displaying unit 160 of exercise recording device 108 of the present embodiment comprises a standard value comparing unit 162 and a predetermined standard displaying unit 164. Predetermined standard displaying unit 164 comprises a color setting unit 168.

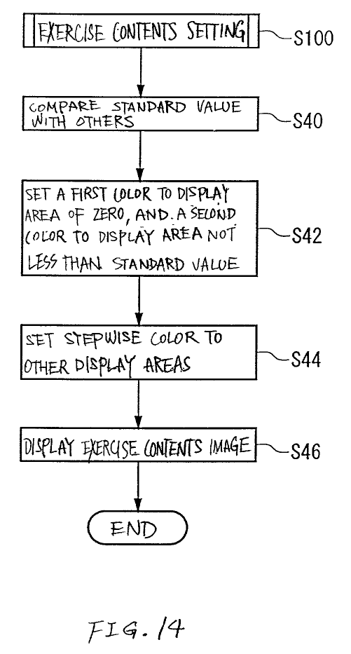

FIG. 14 shows a flowchart of the process displaying image based on the exercise contents, while exercise recording system 10 of the present embodiment records user 20's exercise. Continuous processes (S100) of the exercise contents setting will not be explained since they are same as the first embodiment.

Standard value comparing unit 162 of exercise contents displaying unit 160 of exercise recording device 108, compares a predetermined standard value with exercise contents of a plurality of exercising parts that are integrated in exercise contents integrating (S40). If the same example as the first embodiment is used for explaining, the predetermined standard value is compared with exercise contents for left/right upper arms, left/right lower arms, trunk, left/right upper legs, and left/right lower legs, respectively.

For example, values except the standard value are expressed by percentage with respect to the standard value. For explanation, the predetermined standard value is assumed to 20. In the above example, if the exercise contents of the left/right upper arms is 14, the value of the exercise contents is expressed by 70%. Further, if the value of the exercise contents is 25, the exercise contents is expressed by 125%.

Predetermined standard displaying unit 164 of exercise contents displaying unit 160 sets exercise contents image of a plurality of display areas, based on the comparison of standard comparing unit 162. In the present embodiment, the following images are set in the plurality of display areas.

Color setting unit 168 of predetermined standard displaying unit 164 sets a first color in the display area corresponding to the exercising part whose exercise contents is zero. Further, color setting unit 168 sets a second color in the display area corresponding to the exercising part whose exercise contents is not less than the predetermined standard value (S42). For example, cold color such as blue is set for the first color and warm color such as red is set for the second color. User 20 can visually recognize its past exercise contents, with ease. In the above example, red is set for the display area corresponding to the left/right lower arms. Further, if the value of exercise contents of the left/right upper legs is zero, blue is set for the display area corresponding to that.

In the display areas corresponding to the plurality of exercising parts whose exercise contents is less than the predetermined value, color setting unit 168 sets a color that is closer to the second color in a display area corresponding to the exercising part whose exercise contents is closer to the predetermined standard value, based on the comparison by the standard value comparing unit, among the colors which step wise vary between the predetermined first color and the predetermined second color. For example, five colors between blue and red are prepared. According to the result of comparison by the standard value comparing unit, color setting unit 168 sets blue in the display area of 0%, light blue in the display area between 0 & and 20%, green in the display area between 20% and 40%, yellow in the display area between 40% and 60%, orange color in the display area between 60% and 80%, and red in the display area between 80% and 100%.

Displaying device 200 displays exercise contents image having a plurality of display areas that are set as in the above (S46). The displays of the exercise contents image are same as the first embodiment.

The fifth embodiment can provide the same effects as the first embodiment. Further, since other display areas are displayed by the result of comparison with the standard value, the exercising part where absolute value of exercise contents is low can be easily recognized. In particular, if an exercise contents is low with respect to all of the exercising parts, that is, if exercise is not much performed in the exercise recording system, such a record is outstandingly displayed.

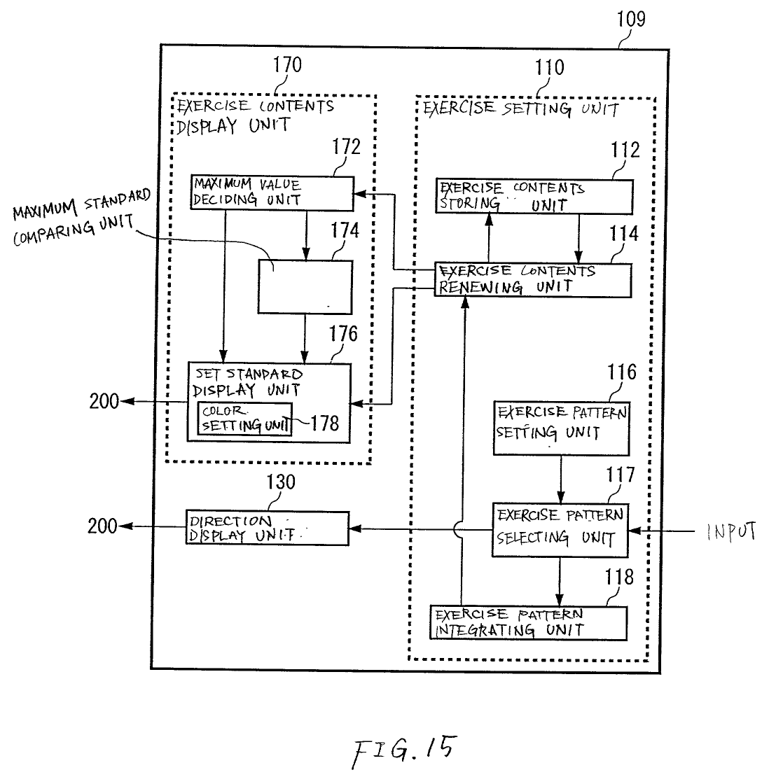

FIG. 15 shows a functional block diagram of exercise recording device 109 of the exercise system according to a sixth embodiment of the present invention. Exercise recording system of the sixth embodiment is different from the exercise recording system of the first embodiment in exercise recording device 109.

Exercise recording device 109 of the present embodiment has an exercise contents setting unit 110, a direction displaying unit 130, and an exercise contents displaying unit 170. Exercise contents setting unit 110 of exercise recording device 109 and direction displaying unit 130 are same as the first embodiment, and thus explanation to them is omitted.

Exercise contents displaying unit 170 of exercise recording device 109 of the present embodiment comprises a maximum value deciding unit 172, a maximum standard comparing unit 174, and a set standard display unit 176. Set standard display unit 176 comprises a color setting unit 178.

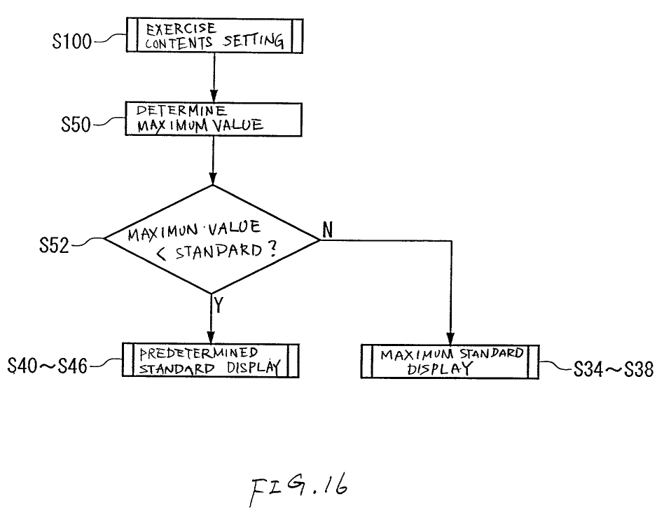

FIG. 16 shows a flowchart of process of displaying image based on exercise contents, while exercise recording system 10 according to the present embodiment records user 20's exercise. Processes of exercise contents (S100) will not be explained since they are same as the first embodiment.

Maximum value setting unit 172 of exercise contents displaying unit 170 in exercise recording device 109 decides the maximum value among the exercise contents of a plurality of exercising parts that are integrated in exercise contents integrating unit 114 (S50). Maximum standard comparing unit 174 compares the maximum value with a predetermined standard (S52).

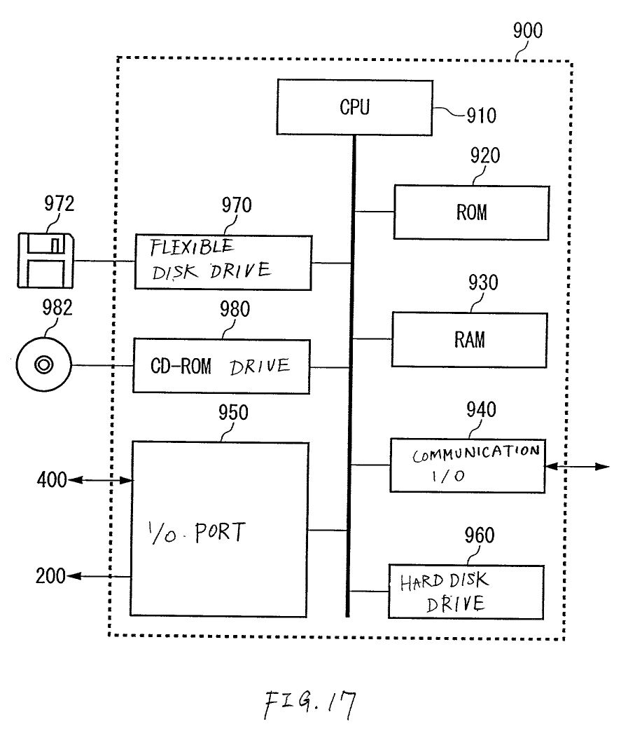

If the maximum value is less than the predetermined value, set standard display unit 176 conducts processes as in FIG. 14 relating to the fifth embodiment (to S46 from S40). Further, in FIG. 17, these processes are shown as “predetermined standard.” On the other hand, if the maximum value is not less than the standard value, set standard display unit 176 conducts the same processes as in FIG. 7 relating to the first embodiment (to S38 from S34). Further, in FIG. 17, these processes are shown as “maximum standard display.”

The sixth embodiment can provide the same effects as the first embodiment. Further, if an exercise contents is low with respect to all of the exercising parts, that is, if exercise is not much performed in the exercise recording system, such a record is outstandingly displayed. If exercise contents becomes great unusually for some exercising part, such a record is outstandingly displayed.

FIG. 17 shows a block diagram showing hardware of exercise recording device 900 of exercise recording system 10 according to a seventh embodiment. Exercise recording device 900 has CPU 910, ROM 920, RAM 930, communication interface 940, input/output port 950, and hard disk drive 960. CPU 910 operates based on a computer program that is stored in ROM 920 and RAM 930.

Communication interface 940 communicates with outside through communication network. Hard disk drive 960 stores a computer program operating the corresponding table and CPU 910. Further, in the present embodiment, hard disk drive 960 stores exercise contents of a plurality of exercising parts, as exercise contents storing unit 112. Input/output port 950 performs data transceiving with exercise detecting device 400.

Exercise recording device 900 has flexible disk drive 970 15 and CD-ROM drive 980. Flexible disk drive 970 reads out data or computer program from flexible disk 972 and provides it to CPU 910. CD-ROM drive 980 reads out data or computer program from CD-ROM 982 and provides it to CPU 910. Communication interface 940 is connected to the Internet and transceives data.

Software that is run by CPU 910 is stored in recording medium such as flexible disk 972 or CD-ROM 982 and is provided to a user. The software stored in a recording medium may be compressed or may not be compressed. The software is installed in hard disk drive 960 from the recording medium and is retrieved in RAM 930 to be run by CPU 910.

Software that is stored in recording medium and is provided, that is, the software that is installed in hard disk drive 960, has an exercise contents setting step of setting exercise contents for a plurality of exercising body parts, an exercise contents displaying step of displaying the exercise contents having a plurality of display areas corresponding to the plurality of exercising parts, respectively, based on the exercise contents. The software is an example of a computer program of exercise recording system according to the present invention. The processes that are run in CPU 910 according to each step included in this software are same as the function and operation of the corresponding elements, respectively, in exercise recording system 100 according to the present invention, and thus, explanation to them is omitted.

In flexible disk 972 or CD-ROM 982 that is shown in FIG. 17, it is possible to store a portion or the whole of the functions of the operation of exercise recording device 900 of exercise recording system 10 described in all of the embodiments described in this application.

Even if these computer programs are directly retrieved in RAM from recording medium and are executed, the computer programs may be retrieved in RAM after it is installed in hard disk drive and may be executed thereafter. Further, the computer program can be stored in one or more recording medium. Each step of the computer program that is stored in recording medium may provide each function together with operating system. For example, it may request the operating system to perform a portion or the whole of the functions and provide functions, based on the response from the operating system.

As recording medium, further to flexible disk and CD-ROM, optical recording medium such as DVD, magnetic recording medium such as MD, magneto-optical recording medium such as PD, tape medium, magnetic recording medium, semiconductor memory such as IC card and miniature card can be used. These recording media are examples of the recording medium relating to the present invention. Further, the computer program may be provided to exercise recording device 900 of exercise recording system 10 through communication network, if storing device such as hard disk provided in server system which is connected to dedicated communication network or the Internet and if RAM is used as recording medium.

An example of exercise recording device 900 of exercise recording system 10 is home video game machine. However, it is not limited to the machine. Another example comprises exercise supporting device that is provided in a fitness club, arcade game machine that is provided in a theme park and the like.

Further, the exercise contents of a plurality of exercising parts that are stored in hard disk drive 960 is written in flexible disk 972 and the written data can be read by or written in other exercise recording system. Alternatively, the written data in flexible disk 972 can be read by and written other exercise recording system.

In the above, the present invention is described with reference to the embodiments, but the scope of the present invention is not limited to the embodiments. It is possible to variously modify or improve the embodiments. It is clearly understood from the claims that the modified or improved embodiments can also fall within the scope of the present invention.

As clearly understood from the above, according to the present invention, a user can visually recognize the exercise recording with ease. Thus, the user can easily decide which body parts should be trained thereafter.

Although the present invention has been described by way of exemplary embodiments, it should be understood that those skilled in the art might make many changes and substitutions without departing from the spirit and the scope of the present invention which is defined only by the appended claims.

What is claimed is:

1. A recording medium where a computer program of exercise recording system for recording a user's body exercise is readably recorded by an exercise recording system, said computer program making the exercise recording system operate:
an exercise contents setting step of setting exercise contents for a plurality of exercising parts of the body; and
an exercise contents displaying step of displaying exercise contents image having a plurality of display areas corresponding to the plurality of exercising parts, respectively, based on the exercise contents thus set.

2. The recording medium according to claim 1, wherein the computer program further makes the exercise recording system operate:
an exercise contents storing step of storing the exercise contents of the plurality of exercising parts; and
an exercise contents renewing step of integrating newly set exercise contents with the exercise contents stored in said exercise contents storing step, and resetting exercise contents.

3. The recording medium according to claim 2, wherein said exercise contents setting step further includes:
an exercise pattern setting step of setting a plurality of exercise patterns having exercise contents parameters corresponding to the plurality of exercising parts, respectively;
an exercise pattern selecting step of selecting a predetermined exercise pattern from the plurality of exercise patterns that are set in said exercise pattern setting step; and
an exercise pattern integrating step of setting the exercise contents parameter of the predetermined exercise pattern selected in said exercise pattern selecting step as said new exercise contents integrated in said exercise contents renewing step.

4. The recording medium according to claim 3, wherein said computer program further makes said exercise system operate a direction image displaying step of displaying exercise direction image for directing an exercise of the exercise pattern to the user, corresponding to the predetermined exercise pattern which is selected in the exercise pattern selecting step.

5. The recording medium according to claim 4, wherein said exercise contents setting step further includes a direction completion determining step of determining whether the display of the exercise direction image of the predetermined exercise pattern is completed in said direction image displaying step, and if it is determined that the display of the exercise direction image is completed, setting the exercise contents parameter of the predetermined exercise pattern as the new exercise contents integrated in said exercise contents renewing step in said exercise pattern integrating step.

6. The recording medium according to claim 3, wherein said computer program further makes said exercise system operate a sound outputting step of outputting sounds corresponding to the predetermined exercise pattern that is selected in said exercise pattern selecting step.

7. The recording medium according to claim 6, wherein said exercise contents setting step further includes a sound completion determining step of determining whether the sound output of said predetermined exercise pattern is completed in said sound out putting step, and if it is determined that the sound output is completed, setting the exercise contents parameter of the predetermined exercise pattern as the new exercise contents that is integrated in said exercise contents renewing step.

8. The recording medium to claim 2, wherein said exercise contents setting step further includes an exercise performance information gathering step of:
gathering exercise performance information based on a fact that the user actually exercises the plurality of exercising the body, and
setting exercise performance parameter based on the exercise performance information as the new exercise contents of the plurality of exercising parts that is integrated in said exercise contents resetting step.

9. The recording medium according to claims 1, wherein said exercise contents displaying step includes a color setting step of setting colors in the plurality of display areas of the exercise contents image corresponding to the plurality of exercising parts, respectively, based on the exercise contents.

10. The recording medium according to claim 2, wherein said exercise contents displaying step may includes:
a maximum value deciding step of deciding the maximum value among the exercise contents of the plurality of exercising parts that are integrated in said exercise contents renewing step;
a maximum value comparing step of comparing the maximum value with the exercise contents of the plurality of exercising parts except the maximum value; and
a maximum standard displaying step of setting the display of the plurality of display areas of the exercise contents image based on the comparison in the maximum value comparing step.

11. The recording medium according to claim 10, wherein said maximum standard displaying step includes a color setting step of:
setting a first color in the display area corresponding to the exercising part where the exercise contents is zero,
setting a second color in the display area corresponding to the exercising part of the maximum value, and
setting, in the display areas corresponding to the plurality of exercising parts where exercise contents is not the maximum value, a color that is closer to the second color in a display area corresponding to the exercising part where exercise contents is closer to the maximum value, based on the comparison by said maximum value comparing step, among the colors which stepwise vary between the first color and the second color.

12. The recording medium according to claim 2, wherein said exercise contents displaying step includes:
a standard value comparing step of comparing a predetermined standard value with the exercise contents of the plurality of exercising parts that are integrated in said exercise contents renewing step; and
a predetermined standard value displaying step of setting the plurality of display areas of the exercise contents image based on the comparison in said standard value comparing step.

13. The recording medium according to claim 12, wherein said predetermined standard displaying step includes a color setting step of:
setting a first color in the display area corresponding to the exercising part where the exercise contents is zero;
setting a second color in the display area corresponding to the exercising part where the exercise contents is not less than the predetermined standard value; and
setting, in the display areas corresponding to the plurality of exercising parts where exercise contents is less than the standard value, a color that is closer to the second color in a display area corresponding to the exercising part where exercise contents is closer to the predetermined standard value, based on the comparison in said standard comparing step, among the colors which stepwise vary between the first color and the second color.

14. The recording medium according to claim 2, wherein the exercise contents displaying step includes:
a maximum value deciding step of deciding the maximum value among the exercise contents of the plurality of exercising parts that are integrated in the exercise contents renewing step;
a maximum standard comparing step of comparing the maximum value with a predetermined standard value; and
a set standard displaying step of,
if the maximum value is less than the predetermined standard value, comparing the predetermined standard value with the exercise contents of said plurality of exercising parts and setting the plurality of display areas of the exercise contents image based on the comparison and of,
if said maximum value is not less than the predetermined standard value, comparing the maximum value with the exercise contents of the plurality of exercising parts except the maximum value and setting the plurality of display areas of the exercise contents display based on the comparison.

15. The recording medium according to claim 14, wherein said set standard comparing step includes:
a color setting step of setting a first color in the display area corresponding to the exercising part where exercise contents is zero;
if said maximum value is less than said predetermined standard value, setting a second color in the display area corresponding to the exercising part where exercise contents is not less than the predetermined standard value and setting, in the display areas corresponding to the plurality of exercising parts whose exercise contents is less than the predetermined value, a color that is closer to the second color in a display area corresponding to the exercising part whose exercise contents is closer to the predetermined standard value, based on the comparison in said standard value comparing step, among the colors which stepwise vary between the predetermined first color and said predetermined second color; and
if said maximum value is not less than the predetermined standard value, setting a second color in the display area corresponding to the exercising part of the maximum value, and setting, in the display areas corresponding to the plurality of exercising parts where exercise contents is not the maximum value, a color that is closer to the second color in a display area corresponding to the exercising part whose exercise contents is closer to the maximum value, based on the comparison by the maximum value comparing step, among the colors which stepwise vary between the first color and the second color.

16. An exercise recording device for recording a user's body exercise, said device comprising:
an exercise contents setting unit for setting exercise contents for a plurality of exercising parts of the body; and
an exercise contents displaying signal outputting unit for outputting exercise contents displaying signal of displaying exercise contents image having a plurality of display areas corresponding to the plurality of the exercising parts, based on the exercise contents, respectively.

17. An exercise recording system for recording a user's body exercise, said system comprising:
an exercise recording device comprising an exercise contents setting unit for setting exercise contents for a plurality of exercising parts of said body, and an exercise contents displaying signal outputting unit for outputting exercise contents displaying signal of displaying exercise contents image having a plurality of display areas corresponding to the plurality of the exercising parts, based on the exercise contents, respectively; and
a displaying device for selectively displaying an exercise contents image based on the signal from the exercise contents displaying signal outputting unit of said exercise recording device and an exercise direction image for directing the exercise to the user.

18. The exercise recording system according to claim 17, wherein said exercise contents setting unit of said exercise recording device includes:
an exercise contents storing unit for storing the exercise contents of the plurality of exercising parts; and
an exercise contents renewing unit for integrating a newly set exercise contents with the exercise contents that is stored in the exercise contents storing unit, and for resetting exercise contents.

19. The exercise recording system according to claim 18, wherein said exercise contents setting unit of said exercise recording device includes:
an exercise pattern setting unit for setting a plurality of exercise patterns having exercise contents parameters corresponding to the plurality of exercising parts, respectively;
an exercise pattern selecting unit for selecting a predetermined exercise pattern from the plurality of exercise patterns that are set by the exercise pattern setting unit; and
an exercise pattern integrating unit for integrating the exercise contents parameter of the predetermined exercise patterns selected by the exercise pattern selecting unit with the new exercise contents that is integrated in the exercise contents renewing unit.

20. The exercise recording system according to claim 19, wherein said exercise recording device further includes a direction displaying unit for outputting a signal that making the exercise direction image corresponding to the predetermined exercise pattern selected by the exercise pattern selecting unit be displayed in the displaying device.

21. The exercise recording system according to claim 20, wherein said exercise contents setting unit of said exercise recording device further includes a direction completion determining unit, said direction completion determining unit determining whether outputting signal of the exercise direction image of the predetermined exercise pattern is completed in said direction displaying unit and if it is determined that the signal output of the exercise direction image is completed, setting the exercise contents parameter of the predetermined exercise pattern as the new exercise contents that is integrated in said exercise contents renewing unit, in said exercise pattern integrating unit.

22. The exercise recording system according to claim 21, further comprising a sound outputting device for outputting sound corresponding to the predetermined exercise pattern selected by the exercise pattern selecting unit.

23. The exercise recording system according to claim 21, wherein said exercise contents setting unit of said exercise recording device further includes a sound completion determining unit, said sound completion determining unit determining whether the sound output of the predetermined exercise pattern is completed in said sound outputting device, and if it is determined that the sound output is completed, setting the exercise contents parameter of the predetermined exercise pattern as the new exercise contents that is integrated by said exercise contents renewing unit.

24. The exercise recording system according to claim 18, further comprising:
a exercise detecting device for detecting the user actually exercising its body, and
wherein said exercise contents setting unit includes,
an exercise performance information gathering unit for gathering exercise performance information based on the detection of the exercise detecting device, and
an exercise performance information integrating unit for setting exercising performance parameter based on the exercise performance information as the new exercise contents of the plurality of exercising parts that is integrated in said exercise contents resetting unit.

25. The exercise recording system according to claim 24, wherein said exercise detecting device includes:
a plurality of exercise detection transmitting units attached to a plurality of the user's body parts and transmitting exercise detecting signal corresponding to the body parts if the user actually exercises said body parts; and
an exercise detection receiving unit for receiving the exercise detecting signal from said plurality of exercise detection transmitting units, and for outputting information of indicating that the exercise is being performed along with information of identifying the exercising part, based on the received exercise detecting signal, as exercise performance information.

26. The exercise recording system according to claims 17, wherein the exercise contents displaying unit of said exercise recording device includes a color setting unit for setting a color of exercise contents image of the plurality of display areas corresponding to the plurality of exercising parts, respectively, based on the exercise contents.

27. The exercise recording system according to claim 18, wherein said exercise contents displaying unit of said exercise recording device includes:
a maximum value setting unit for setting the maximum value among the exercise contents of said plurality of exercising parts that are integrated in the exercise contents integrating unit;
a maximum value comparing unit for comparing the maximum value with the exercise contents of the plurality of exercising parts except the maximum value; and
a maximum standard displaying unit for setting the exercise contents image of the plurality of the display areas based on the comparison by said maximum value comparing unit.

28. The exercise recording system according to claim 27, wherein said maximum standard displaying unit of said exercise contents displaying unit of said exercise recording device includes:
a color setting unit,
setting a first color in the display area corresponding to the exercising part where exercise contents is zero,
setting a second color in the display area corresponding to the exercising part of the maximum value; and
setting, in the display areas corresponding to the plurality of exercising parts whose exercise contents is not the maximum value, a color that is closer to the second color in a display area corresponding to the exercising part whose exercise contents is closer to the maximum value, based on the comparison by the maximum value comparing unit, among the colors which stepwise vary between the first color and the second color.

29. The exercise recording system according to claim 18, wherein said exercise contents displaying unit of said exercise recording device includes:
a standard value comparing unit for comparing a predetermined standard value with the exercise contents of the plurality of exercising parts that are integrated in said exercise contents integrating unit; and
a predetermined standard displaying unit for setting the exercise contents image of said plurality of display areas based on the comparison by said standard value comparing unit.

30. The exercise recording system according to claim 29, wherein said predetermined standard displaying unit of said exercise contents displaying unit of said exercise recording device includes:
a color setting unit,
setting a first color in the display area corresponding to the exercising part where exercise contents is zero,
setting a second color in the display area corresponding to the exercising part whose exercise contents is not less than the predetermined standard value, and
setting, in said display areas corresponding to the plurality of exercising parts whose exercise contents is less than the predetermined value, a color that is closer to the second color in a display area corresponding to the exercising part whose exercise contents is closer to the predetermined standard value, based on the comparison by said standard value comparing unit, among the colors which stepwise vary between the first color and the second color.

31. The exercise recording system according to claim 18, wherein said exercise contents displaying unit of said exercise recording device includes:
a maximum value deciding unit for deciding the maximum value among said exercise contents of the plurality of exercising parts that are integrated in said exercise contents integrating unit;
a maximum standard comparing unit for comparing the maximum value with a predetermined standard value; and
a set standard displaying unit,
for, if the maximum value is less than the predetermined standard value, comparing the predetermined standard value with said exercise contents of the plurality of said exercising parts and setting the image having the plurality of display areas based on the comparison, and
for, if said maximum value is not less than the predetermined standard value, comparing the maximum value with the exercise contents of the plurality of exercising parts except the maximum value and setting the image having the plurality of display areas.

32. The exercise recording system according to claim 31, wherein said set standard displaying unit of the exercise contents displaying unit in the exercise recording device includes:
a color setting unit,
setting a first color in said display area corresponding to the exercising part where exercise contents is zero,
if said maximum value is less than the predetermined standard value, setting a second color in the display area corresponding to the exercising part where exercise contents is not less than the predetermined standard value and setting, in the display areas corresponding to the plurality of exercising parts where exercise contents is less than the predetermined value, a color that is closer to said second color in a display area corresponding to said exercising part whose exercise contents is closer to said predetermined standard value, based on said comparison by said standard value comparing step, among said colors which stepwise vary between said predetermined first color and said predetermined second color; and
if said maximum value is not less than said predetermined standard value, setting a second color in said display area corresponding to said exercising part of said maximum value, and setting, in said display areas corresponding to said plurality of exercising parts whose exercise contents is not said maximum value, a color that is closer to said second color in a display area corresponding to said exercising part whose exercise contents is closer to said maximum value, based on said comparison by said maximum value comparing step, among said colors which stepwise vary between said predetermined first color and said predetermined second color.
